(19) United States
(12) Patent Application Publication
(10) Pub. No.: US 2011/0008140 A1
(43) Pub. Date: Jan. 13, 2011

(54) POWER ACCESS RAMP

(75) Inventors: Eric R. Hansen, Lake Orion, MI (US); Daniel R. Sand, Shelby Township, MI (US)

Correspondence Address: MICHAEL BEST & FRIEDRICH LLP, 100 E WISCONSIN AVENUE, Suite 3300, MILWAUKEE, WI, 53202, US

(73) Assignee: STRATTEC POWER ACCESS LLC, Troy, MI (US)

(21) Appl. No.: 12/863,211

(22) PCT Filed: Feb. 19, 2009
(86) PCT No.: PCT/US2009/034507

§ 371 Date: Sep. 27, 2010

Related U.S. Application Data
(60) Provisional application No. 61/029,793, filed on Feb. 19, 2008.

(51) Int. Cl. A61G 3/06; B60P 1/43

(52) U.S. Cl. 414/523; 414/812

(57) ABSTRACT

Exemplary embodiments of the present invention are directed towards systems and methods for providing improved access to vehicles for physically challenged individuals. In one exemplary embodiment, a wheelchair access system for a vehicle is provided. The system includes a first track and a second track, the first and second tracks being located on opposite sides of the frame assembly. The system also includes a ramp formed of a porous structural member disposed between a first skin member and a second skin member. The ramp has a first edge portion with one or more rollers attached thereto and a second edge portion having one or more rollers attached thereto. The one or more rollers on the first and second edge portions travel within the first and second tracks, respectively, of the frame assembly. The system further includes a drive motor engaging a first rotatable drum member and a second rotatable drum member. The drive motor is configured to rotate the first and second drum members in first and second directions based on a direction of a current flowing through the drive motor. The system still further includes a first cable engaging the first drum member and a second cable engaging the second drum member. The first and second cables are coupled to the ramp such that the first and second cables move the ramp from a stowed position to a deployed position during rotation of the first and second drum members in the first direction.

### RELATED APPLICATION

The present application claims the benefit of prior-filed, co-pending provisional patent application Ser. No. 61/029,793, filed Feb. 19, 2008, the content of which is hereby incorporated by reference.

### FIELD OF THE INVENTION

Exemplary embodiments of the present invention are generally related to systems and methods for providing improved access to vehicles for physically challenged individuals. More particularly, in one exemplary embodiment, the present invention provides a lightweight, reduced cost and/or simplified system and method for accessing the interior of a vehicle for wheelchair bound individuals.

### BACKGROUND

Manufactures of vehicles are continuously realizing the importance of providing transportation to all sectors of society's population. One particular sector is physically challenged individuals. Whether the individual is temporarily or permanently disabled, it is important that all individuals have the ability to freely travel as needed. Many times, this includes providing accommodation and/or alterations to vehicles to provide physically challenged individuals with access and/or control of the vehicle. This includes personal vehicles, vehicles for hire (e.g., taxi cabs, buses, trains, airplanes, etc.) or otherwise.

One access configuration for physically challenged individuals include a ramp system for providing access to an interior of a vehicle, particularly a mini-van or the like. In one power ramp system, a ramp is moved between a deployed position and a stowed position. However, the power ramp system has an extremely heavy ramp which is difficult to install and/or move.

Accordingly, in view of the foregoing, there is a need for an improved vehicle access system for physically challenged individuals.

### SUMMARY OF THE INVENTION

Exemplary embodiments of the present invention provide improved systems and methods for providing access to interior portions of a vehicle by physically challenged individuals.

In one exemplary embodiment, a wheelchair access system for a vehicle is provided. The system includes a frame assembly defining a first track and a second track, the first and second tracks being located on opposite sides of the frame assembly. The system also includes a ramp formed of a porous structural member disposed between a first skin member and a second skin member. The ramp has a first edge portion with one or more rollers attached thereto and a second edge portion having one or more rollers attached thereto. The one or more rollers on the first and second edge portions travel within the first and second tracks, respectively, of the frame assembly. The system further includes a drive motor engaging a first rotatable drum member and a second rotatable drum member. The drive motor is configured to rotate the first and second drum members in first and second directions based on a direction of a current flowing through the drive motor. The system still further includes a first cable engaging the first drum member and a second cable engaging the second drum member. The first and second cables are coupled to the ramp such that the first and second cables move the ramp from a stowed position to a deployed position during the rotation of the first and second drum members in the first direction.

In another exemplary embodiment, a method of deploying and stowing a wheelchair access ramp of a vehicle is provided. The method includes applying a first current through a drive motor in a first direction to cause rotation of a first drum member and a second drum member in a first rotational direction, such that first and second cables attached to the first and second drum members, respectively, move the ramp member toward a deployed position. The method also includes applying a second current through the drive motor in a first direction to cause rotation of the first drum member and the second drum member in a second rotational direction such that first and second cables attached to the first and second drum members, respectively, move the ramp member toward a stowed position.

The above-described and other features and advantages will be appreciated and understood by those skilled in the art from the following detailed description, drawings, and appended claims.

### BRIEF DESCRIPTION OF THE DRAWINGS

Other objects, features, advantages and details appear, by way of example only, in the following detailed description of embodiments, the detailed description referring to the drawings in which:

FIG. 1 illustrates a perspective view of a wheelchair access system in a deployed position according to one exemplary embodiment of the present invention;

FIG. 2 illustrates a perspective view of a wheelchair access system in a stowed position according to one exemplary embodiment of the present invention;

FIG. 3 illustrates a perspective view of a track of a frame assembly according to one exemplary embodiment of the present invention;

FIG. 4 illustrates a schematic side view of a trace of a frame assembly according to one exemplary embodiment of the present invention;

FIG. 5 illustrates a perspective view of a drive motor and drum member according to one exemplary embodiment of the present invention;

FIG. 6 illustrates a cross-section view through a portion of a frame assembly and ramp according to one exemplary embodiment of the present invention; and

FIG. 7 illustrates a cut away perspective view of a ramp according to one exemplary embodiment of the present invention.

### DESCRIPTION OF THE EMBODIMENTS

Exemplary embodiments of the present invention provide improved systems and methods for providing access to interior portions of a vehicle for physically challenged individuals. In one exemplary embodiment, the improved systems and methods are through the formation of a wheelchair access system having a reduced weight and simplified design. The reduction in weight not only improves potential fuel efficiency of the vehicle but also reduces the power requirement of an actuation drive motor. The reduction in weight is achieved through a combination of features designed to reduce weight of the system yet still provide suitable strength to support individuals entering and exiting the vehicle.

In another exemplary embodiment, the improved system and method includes the use of an improved actuation system for the wheelchair access system. The actuation system is configured to move a ramp between a deployed position and a stowed position. The improved actuation system includes one or more advantageous features such as improved drive motor, quadrature position sensor, electromagnetic clutch, cable configuration and other advantageous features.

Through the above referenced features, and other features shown and described herein, the wheelchair access system provides an improved system having a simplified designed and reduced weight.

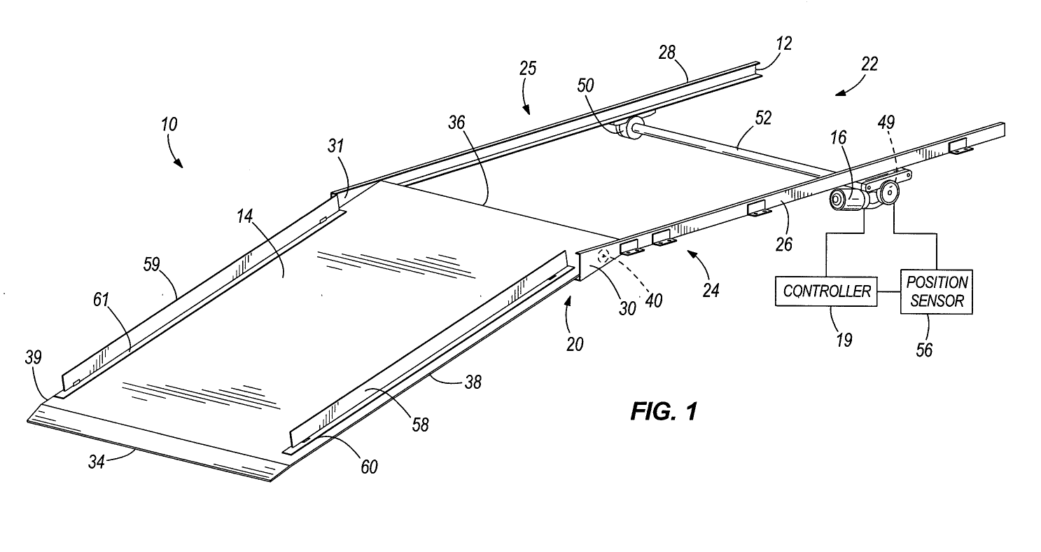

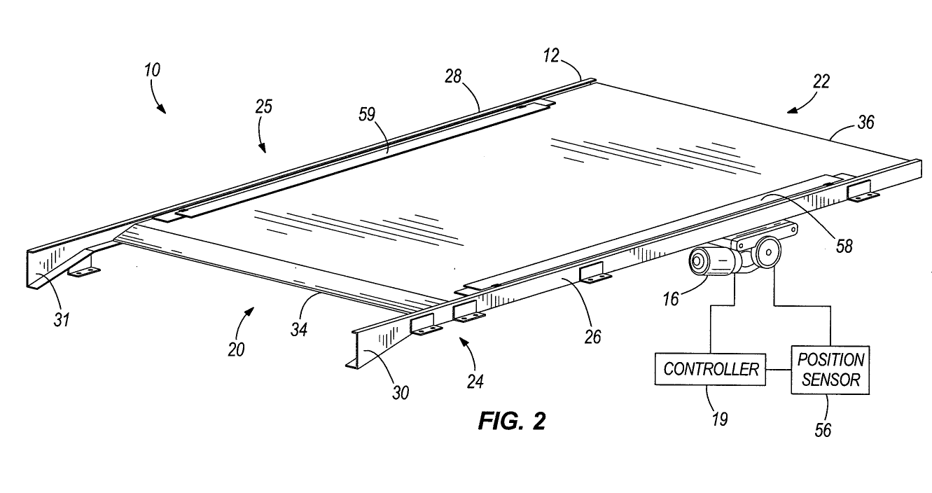

Referring to FIGS. 1 and 2, exemplary embodiments of a wheelchair access system 10 are shown. Generally, the system 10 includes a frame assembly 12, a ramp 14, a drive motor 16, cables 17, 18, drum members 49, 50 and a controller 19. The frame assembly 12 is adapted to be mounted to a portion of a vehicle. The frame assembly is configured for engaging and supporting a ramp 14 suitable in strength for supporting an individual entering or exiting the vehicle. The ramp is moveable along the frame assembly, and between a deployed position and a stowed position, utilizing the drive motor 16. The drive motor is in driving relationship with the ramp through cables 17, 18, which are supported at one or more locations along the frame assembly. It should be appreciated that one or more components of the wheelchair access system is controlled through the controller 19.

In operation, upon activation of the wheelchair access system 10 to cause deployment of the ramp, the drums members connected to the drive motor engages the cables to move the ramp along the frame to cause movement of the ramp from the frame assembly to a deployed position. Upon activation of the wheelchair access system to cause stowage of the ramp, the drive motor again engages the cables, through the drum members, to move the ramp back into the frame assembly to a stowed position. It should be appreciated, as shown and described herein, that other features may be utilized as well.

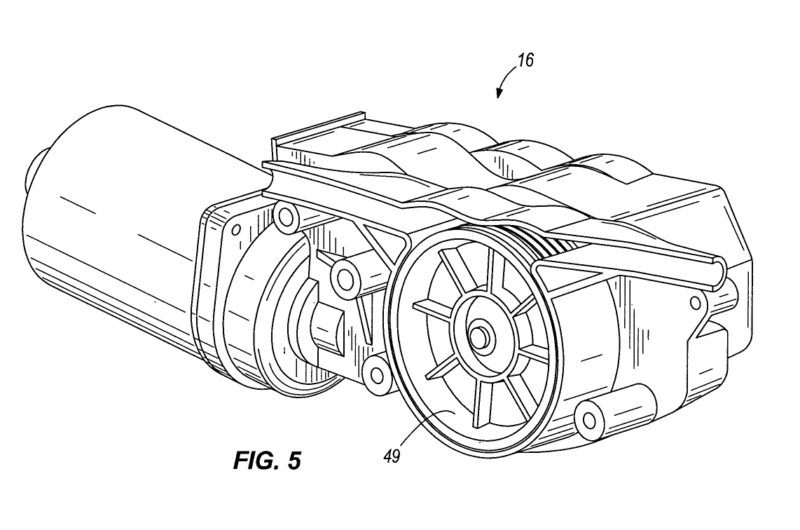

In further detail, the frame assembly is formed of one or more members configured to support the ramp and optionally attachment to a vehicle. In one exemplary embodiment, the frame assembly 12 forms a first track portion 26 and a second track portion 28. The first and second track portions extend from forward portion 20 to rearward portion 22 of the frame assembly. In one configuration, the first and second track portions are configured for receiving and guiding one or more rollers or wheels between the forward portion and the rearward portion of the frame assembly. In one exemplary embodiment, as shown in FIG. 5, the first and second track positions include a generally C-shaped cross-sectional shape, that are inwardly facing with respect to the frame assembly. The frame assembly also includes a forward portion 20, a rearward portion 22, a first side portions 24 and a second side portion 25. The forward portion includes an opening for allowing the ingress and egress of the ramp.

In one exemplary embodiment, first and second tracks 26, 28 include an end portion, located towards the forward portion of frame assembly 12, that form a first sloped or tapered portion 30 and a second sloped or tapered portion 31, with respect to other portions of the first and second tracks. Advantageously, as shown in FIG. 1, the sloped portion is configured for angling ramp 14 towards a ground surface surrounding the vehicle during deployment of the ramp. In this configuration, as the ramp exists the frame assembly, the angle of the ramp, with respect to the first and second tracks, increases as the ramp is continuously deployed. During stowage of the ramp, as shown in FIG. 2, the sloped portion guides the ramp into the frame assembly. It should be appreciated that the sloped portion may also provide support of the ramp in a deployed or stowed position or during deployment and stowage of the ramp.

In one exemplary embodiment, frame assembly 12 includes one or more mounting features for attachment of the frame assembly, and wheelchair access system, to a vehicle. In one configuration, the mounting feature comprises one or more openings formed through the frame assembly, or brackets attached thereto, for engaging suitable mechanical fasteners configured to engage corresponding engagement features of the vehicle, such as a frame member of the vehicle. Other configurations should be appreciated.

Frame assembly 12 is further configured to provide support to cables 17, 18 extending between drum members 49, 50 and ramp 14. In one exemplary embodiment, the cable support comprises one or more, or plurality, of pulleys 32 attached to the frame assembly configured for engaging, guiding and providing support to the cable. Other configurations should be appreciated for providing support to the cables.

The frame may be formed of any suitable material configured for providing support to the ramp and optionally attachment of the wheelchair access system to a vehicle. For example, suitable materials that may be used to form the frame assembly include metal, plastic, rubber, ceramics, combinations thereof or otherwise. In one exemplary embodiment, the material forming the frame assembly comprises a metal such as aluminum, stainless steel, or otherwise. In another exemplary embodiment, the material forming the frame assembly comprises a high strength plastic. Such plastic may include one or more reinforcement features such as fibers, or otherwise, for providing improved strength and durability of the frame assembly.

The ramp of the wheelchair access system is suitable in strength to support individuals entering and exiting a vehicle. The ramp includes a forward edge 34, a rearward edge 36, a first side edge 38 and a second side edge 39 corresponding to the forward, rearward and first and second side portions of the frame assembly. The shape of the ramp is suitable for being stowed within frame assembly 12.

Ramp 14 includes one or more, or plurality, of rollers 40 located on one or both first and second sides edges 38, 39 of the ramp for providing support thereto. In one exemplary embodiment, the ramp includes at least one roller on each side of the ramp. The rollers reside and move within first and second tracks 26, 28 to provide support to the ramp during deployment and stowage thereof.

In one exemplary embodiment, ramp 14 is formed of a lightweight composite material. The composite material includes a lightweight center member 42 interposed between two skin members or outer members 44, 46. In one exemplary embodiment the center member comprises a porous member. In one configuration, the porous member includes a plurality of openings 48 formed through the center member. The plurality of openings may be arranged to form a pattern extend along a length or width, or both, of at least a portion of the center member and in one configuration along the majority of the center member. In one particular example, referring to FIG. 6, the porous center member includes a honeycomb like pattern of openings formed therethrough. Other geometric and non-geometric configurations are contemplated.

Optionally, in one exemplary embodiment, the ramp further includes one or more guild rails for providing guidance for a wheel chair traveling along the ramp. For example, as shown in FIGS. 1 and 2, ramp 14 may include a first guide rail 58 and a second guide rail 59 located towards the first and second side edges 38, 39 of the ramp, respectively. The first and second guide rails 58, 59 include a first hinge 60 and a second hinge 61 for rotatably mounting the first and second guide rails to the ramp.

The first and second guide rails are adapted to rotate to a deployed position, e.g., extending upwards with respect to the ramp, and a stowed position, e.g., laying against a top surface of the ramp. In one exemplary embodiment, the first and second guide rails rotate upwards to the deployed position upon deployment of the ramp and the first and second guide rails rotate downward to the stowed position during stowage of the ramp.

The first and second guide rails may be rotatable connected to one or more suitable drive motors for causing rotation of the first and second guide rails to the deployment and stowed position. In one exemplary embodiment, movement of the first and second guide rails, and hence the suitable drive motors, are controlled through controller 19.

The ramp may be formed of any suitable material. The material forming the components of the ramp may be the same or different. Suitable materials for forming one or more, or even all, of the components of the ramp include metals, plastics, reinforced plastics, rubber, ceramic, combinations thereof or otherwise. Examples of suitable metal include aluminum, stainless steel or otherwise. In one exemplary embodiment, the center member, outer members or both are formed of a plastic material. In one exemplary embodiment, the center member, outer members or both are formed of a metal material, such as aluminum, stainless steel or otherwise. Other configurations are contemplated.

The wheelchair access system may include one or more drive motors 16 for causing deployment and stowage of ramp 14, in one exemplary embodiment, due to the lightweight nature of the ramp, and wheelchair access system configuration, a single drive motor 16 is used to extend and retract the ramp. The motor may be attached in any suitable location; however, in one exemplary embodiment the drive motor is mounted to one of the first or second side portions 30, 31 of frame assembly 12 and is located proximate or mounted to one of first or second tracks 26, 28.

In one exemplary embodiment, drive motor 16 includes a permanent magnet configured to cause rotation of a drive shaft in a first direction based upon current flow through the drive motor in a first direction and cause rotation of the drive shaft in a second direction based upon current flow through the drive motor in a second direction. In this configuration, the drive motor is configured to operate in response to direct current (DC) flowing therethrough. Other motor configurations are contemplated.

Optionally, in one exemplary embodiment, drive motor 16 also includes a clutch for disengagement of the drive motor from cables 17, 18 to allow for manual deployment or stowage of ramp 14. In configuration, this is achieved through the disengagement of the drive motor from the drum members. In one configuration, the clutch comprises an electromagnetic clutch configured to disengage the cables upon termination of current to the drive motor. Other clutch configurations are contemplated.

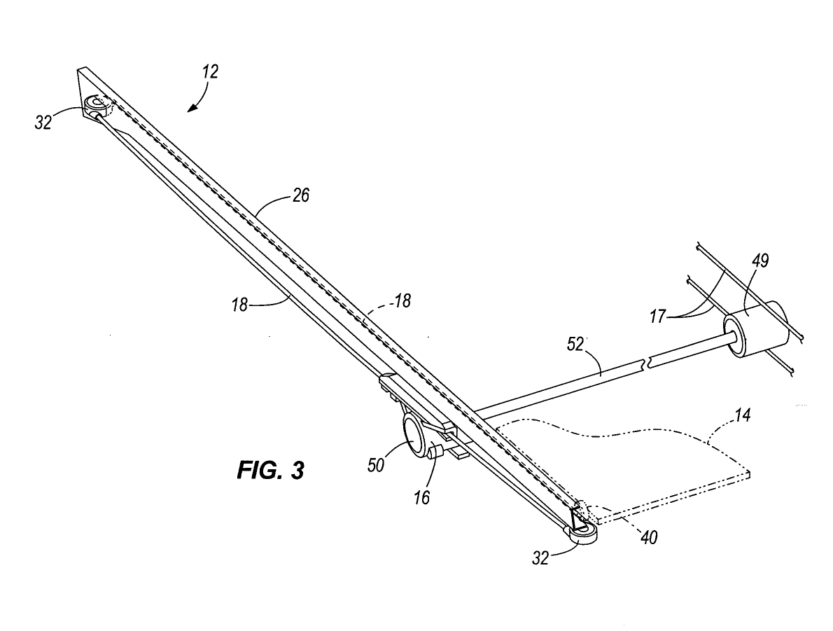

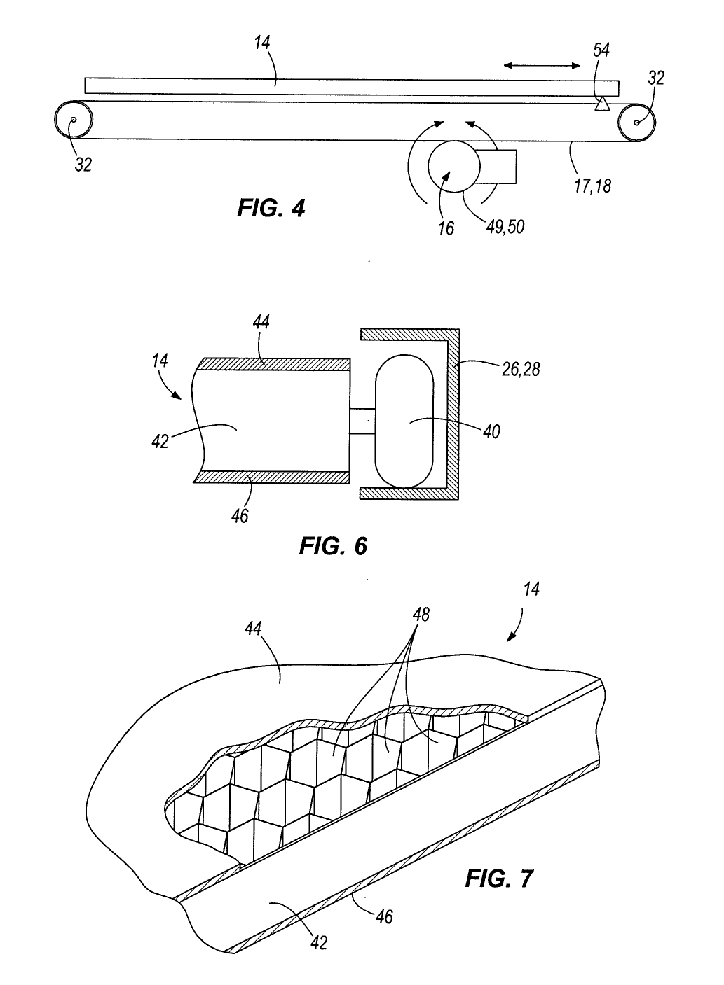

In one exemplary embodiment, drive motor 16 includes, or is linkably attached to, one or more rotatable drum members 49, 50 for engagement with one or more cables 17, 18. Alternatively, the drum members may be configured for engagement with a belt. The one or more rotatable drum members are linkably attached to drive motor 16, either directly or through a connector such as a torque tube, for receiving rotational force. For example, referring to FIGS. 2 and 3, examples of a suitable drive motor 16 and drum members 49, 50 are shown. In these configurations a first drum member is located with the drive motor mounted on or proximate to the first or second track and a second drum member is located on the other of said first or second track. The second drum member is linkably attached to the first drum member, drive motor or both through a suitable connector 52 such as a torque tube. Each drum member is in driving engagement with a cable 17 or 18 extending between a forward portion and rearward portion of the frame assembly 12 and is supported by one or more pulleys 32. The cables are attached to the ramp through a suitable attachment 54 for providing movement of the ramp.

The wheelchair access system may further include one or more sensors 56 for monitoring various characteristics of ramp 14. For example, in one exemplary embodiment, one or more sensors are included for determining position of the ramp, movement direction of the ramp, speed of the ramp or otherwise. Information obtained through the sensors are particularly advantageous for determining interruptions in movement of the ramp, such as during interference with an obstacle or when the ramp reached a deployed or stowed position. In one configuration, the sensor is in communications with controller 19 for providing information relating to the ramp.

In one exemplary embodiment, the wheelchair access system includes a quadrature position sensor. Such sensor is capable of determining position, movement direction and speed of the ramp by monitoring current through the drive motor or otherwise. For example, the sensor may be configured to generate a signal based upon completion of deployment or stowage of the ramp. The sensor is further configured to transmit a signal based upon the state of current through the drive motor to determine whether motion of the ramp should be discontinued or otherwise. For example, should an obstacle interfere with movement of the ramp the resistance to the ramp will change one or more characteristics of the current traveling through the drive motor. The sensor would then transmit a signal indicating that movement of the ramp should be discontinued. Other configurations are contemplated.

In one exemplary embodiment, wheelchair access system 10 may further include a controller for controlling one or more components of the system. For example, referring to FIG. 1, controller 19 may be in communication with drive motor 16, a power supply, or a component therebetween for controlling power to the drive motor. The power, e.g., current, may be directed in the first direction or second direction for controlling deployment or stowage of ramp 14. The controller may also be configured to terminate power to the drive motor or otherwise provide for manual control of the ramp for deployment and/or stowage of the ramp. Also, the controller may be in communications with one or more sensor 56, whereby the controller is configured to terminate power to the drive motor upon occurrence of an obstacle or otherwise. Other configurations are contemplated.

Referring to the drawings, exemplary embodiments of the wheelchair access system 10 of the present inventions are shown. The wheelchair access system includes a frame assembly 12 configured for attachment to a component of a vehicle, through suitable fasteners. The frame assembly includes a first track 26 and a second track 28 extending between a forward portion 20 and rearward portion 22 of the frame assembly. The frame assembly is configured to receive a ramp 14 in a stowed position and guide the ramp to deployed position.

The ramp is formed of a plurality of layers forming a composite component. The layers include a center member 42, and two outer opposing outer members 44, 46. The ramp further includes one or more rollers 40 (e.g., cam rollers or otherwise) extending from first and second side edges 38, 29 of the ramp. The rollers engage and travel within the first and second tracks of the frame assembly. In one configuration, the ramp includes two rollers 40 located on each of the first and second side edges of the ramp and further located towards rearward edge 36 of the ramp. In this configuration, the rollers may be configured to provide support to the ramp through engagement with first and second tracks 26, 28. Optionally, the ramp may further include one or more additional rollers located on each side edge 38, 29 of the ramp and towards forward edge 34 of the ramp and/or at a location between the forward edge and the rearward edge of the ramp. These additional rollers 40 provide reduced friction between the ramp and the frame assembly during deployment or stowage of the ramp.

Optionally, in one exemplary embodiment, one or more of the roller may be substituted with a friction reducing member, such as a bearing member. Such bearing member may be dynamically mounted (e.g., rotatable or otherwise) or be statically mounted. Also, such bearing members may be located anywhere, or even along the entirety, of the ramp and/or first and second tracks to reduce friction therebetween.

Movement of the ramp is controlled through first and second cables 17, 18, which are attached to the ramp through suitable attachment 54 and a single drive motor 16 through a plurality of pulleys 32 attached to the frame assembly. Upon activation of the drive motor, first and second drum members 49, 50 engage first and second cables 17, 18, respectively, to move the ramp to a deployed position, stowed position or otherwise.

Activation and power to the drive motor is achieved through controller 19. The controller controls current to the drive motor to effectuate direction and speed of the motor and hence ramp. Optionally, the drive motor includes an electromagnetic clutch configured to decouple the drive motor from the ramp for providing manual movement of the ramp. The controller may also be in communications with one or more sensors for monitoring operation of the wheelchair access system.

Exemplary embodiments of the present invention also include a method of deploying and stowing a wheelchair access ramp of a vehicle. The method includes directing a current through a drive motor 16 in a first direction to cause movement of a first drum member and a second drum member in a first rotational direction. The movement of first and second drum members 49, 50 in the first rotational direction causes deployment of a ramp member 14. The method further includes directing the current through drive motor 16 in a second direction to cause movement of the first drum member and the second drum member in a second rotational direction. The movement of the first and second drum members in the second rotational direction causes stowage of ramp member 14. The first and second drum members are drivably connected to the ramp through a first cable and a second cable, respectively.

Optionally, the method further includes a controller 19 for directing the current through the drive motor in the first direction and the second direction. The controller may be in communications with one or more sensors 56 being configured to generate a signal based one or more of a position, a movement direction and a speed of the ramp. With regards to position, the sensor may generate a signal based upon whether the ramp is in a deployed position or a stowed position. The sensor may also generate a signal based upon whether the ramp is in contact with an obstacle. In one configuration, the sensor comprises a quadrature position sensor.

Controller 19 is adapted to control one or more functions of drive motor 16. For example, the controller may be configured to terminate power to drive motor to cause disengagement of the drive motor with the first and second cables, through the electromagnetic clutch device. Other steps and features should be appreciated as described and/or shown herein.

While exemplary embodiments have been described and shown, it will be understood by those skilled in the art that various changes may be made and equivalents may be substituted for elements thereof without departing from the scope of the invention. In addition, many modifications may be made to adapt a particular situation or material to the teachings without departing from the essential scope thereof. Therefore, it is intended that the invention not be limited to the particular embodiments disclosed as the best mode contemplated for carrying out this invention, but that the invention will include all embodiments falling within the scope of the appended claims.

What is claimed:

1. A wheelchair access system for a vehicle, comprising:
a frame assembly having a first track and a second track, the first and second tracks being located on opposite sites of the frame assembly;
a ramp formed of a porous structural member disposed between a first skin member and a second skin member, the ramp having a first edge portion with one or more rollers attached thereto and a second edge portion having one or more rollers attached thereto, the one or more rollers on the first and second edge portions traveling within the first and second tracks, respectively, of the frame assembly;
a drive motor engaging a first rotatable drum member and a second rotatable drum member, the drive motor being configured to rotate the first and second drum members in first and second directions based on a direction of a current flowing through the drive motor; and
a first cable engaging the first drum member and a second cable engaging the second drum member, the first and second cables further coupled to the ramp such that the first and second cables move the ramp from a stowed position to a deployed position during rotation of the first and second drum members in the first direction.

2. The wheelchair access system of claim 1, wherein the first and second cables further engaging one or more pulleys attached to the frame assembly for supporting and positioning the first and second cables.

3. The wheelchair access system of claim 1, wherein the first and second tracks have first and second tapered portions, respectively, located at ends of the first and second tracks for angling the ramp with respect to the frame when moving the ramp to the deployed position.

4. The wheelchair access system of claim 1, wherein the porous structural member has an arrangement of openings formed therethrough.

5. The wheelchair access system of claim 4, wherein the openings are arranged to form a honeycomb pattern of openings in the porous structural member.

6. The wheelchair access system of claim 5, wherein at least one of the porous structural member, the first skin member and the second skin member is formed of a metal.

7. The wheelchair access system of claim 1, wherein the drive motor includes a permanent magnet configured to cause rotation of the first and second drum members upon the current flow through the drive motor.

8. The wheelchair access system of claim 7, wherein the drive motor is suitable to drive the first and second rotatable drum members for moving the ramp without using an additional drive motor.

9. The wheelchair access system of claim 8, wherein the drive motor is mounted to the frame assembly and is located proximate to the first track or the second track.

10. The wheelchair access system of claim 1, further comprising an electromagnetic clutch configured to cause disengagement of the drive motor with the first and second drum members upon termination of the current flowing to the drive motor.

11. The wheelchair access system of claim 1, further comprising a sensor for determining a position, a direction and a speed of the ramp.

12. The wheelchair access system of claim 11, wherein the sensor comprises a quadrature position sensor.

13. A method of deploying and stowing a wheelchair access ramp, comprising:
applying a first current through a drive motor in a first direction to cause rotation of a first drum member and a second drum member in a first rotational direction, such that first and second cables attached to the first and second drum members, respectively, move the ramp member toward a deployed position; and
applying a second current through the drive motor in a second direction to cause rotation of the first drum member and the second drum member in a second rotational direction such that first and second cables attached to the first and second drum members, respectively, move the ramp member toward a stowed position.

14. The method of claim 13, further comprising determining a position of the ramp and removing the first current from the drive motor when the ramp has reached the deployed position.

15. The method of claim 13, further comprising determining a position of the ramp and removing the second current from the drive motor when the ramp has reached the stowed position.
